(19) United States
(12) Patent Application Publication
(10) Pub. No.: US 2022/0396675 A1
(43) Pub. Date: Dec. 15, 2022

(54) METHOD FOR PRODUCING A MOLDING COMPOUND HAVING IMPROVED SURFACE PROPERTIES

(71) Applicant: Covestro Intellectual Property GmbH & Co. KG, Leverkusen (DE)

(72) Inventors: Reiner Rudolf, Langenfeld (DE); Michael Erkelenz, Duisburg (DE); Hans-Juergen Thiem, Dormagen (DE)

(21) Appl. No.: 17/774,293

(22) PCT Filed: Dec. 9, 2020
(86) PCT No.: PCT/EP2020/085160

§ 371 Date: May 4, 2022

(30) Foreign Application Priority Data
Dec. 16, 2019 (EP) 19216562.9

(51) Int. Cl. C08J 3/22; B29B 7/90; B29B 7/12; B29B 7/18

(52) U.S. Cl. CPC C08J 3/226; B29B 7/90; B29B 7/12; B29B 7/18; C08J 2369/00; C08K 2003/2241

(57) ABSTRACT

A method for producing a molding compound having improved surface properties is provided. The method relates to, in particular, a molding compound comprising a polycarbonate and at least one reinforcing filler, preferably selected from the group including titanium dioxide (TiO₂), talc (Mg₃Si₄O₁₀(OH)₂), dolomite CaMg[CO₃]₂, kaolinite Al₄[(OH)₈|Si₄O₁₀] and wollastonite Ca₃[Si₃O₉], preferably selected from the group including titanium dioxide (TiO₂) and talc (Mg₃Si₄O₁₀(OH)₂). The total amount of reinforcing filler is 3 to 20 wt. %, preferably 4.5 to 15 wt. %, each relative to the total mass of the molding compound, the molding compound having improved properties being produced using at least one master batch produced according to the method.

### CROSS REFERENCE TO RELATED APPLICATIONS

This application is a U.S. national stage application, filed under 35 U.S.C. § 371, of International Application No. PCT/EP2020/085160, which was filed on Dec. 9, 2020, which claims priority to European Patent Application No. 19216562.9, which was filed on Dec. 16, 2019. The contents of each are hereby incorporated by reference into this specification.

### FIELD

The present invention relates to the production of a molding compound having improved properties. The present invention further relates in particular to the production of a molding compound comprising a polycarbonate and at least one reinforcing filler preferably selected from the group comprising titanium dioxide (TiO₂), talc (Mg₃Si₄O₁₀(OH)₂), dolomite CaMg[CO₃]₂, kaolinite Al₄[(OH)₈|Si₄O₁₀], and wollastonite Ca₃[Si₃O₉], more preferably selected from the group comprising titanium dioxide (TiO₂) and talc (Mg₃Si₄O₁₀(OH)₂). The total content of reinforcing filler is 3% to 20% by weight, preferably 4.5% to 15% by weight, in each case based on the total mass of the molding compound. The molding compound having improved surface properties is produced using at least one masterbatch produced according to the invention.

### BACKGROUND

Masterbatches are known in principle from the prior art, for example from [1] ([1]=Klemens Kohlgrüber: Der gleichläufige Doppelschneckenextruder [The co-rotating twin-screw extruder], 2nd revised and expanded edition, Hanser Verlag, Munich 2016, p. 76 ff).

Also known from the prior art, for example from [1] ([1]=Klemens Kohlgrüber: Der gleichläufige Doppelschneckenextruder [The co-rotating twin-screw extruder], 2nd revised and expanded edition, Hanser Verlag, Munich 2016, p. 47 ff), is the preparation of polymer molding compounds, such as for example also a molding compound comprising a polycarbonate of one of these polymer molding compounds, by admixing additives, for example fillers, such that said polymer molding compounds achieve a desired property profile. This preparation, also referred to as compounding, is generally carried out in a twin-screw extruder. Compounding becomes increasingly difficult as the total content of fillers to be dispersed in the polymer molding compound rises and the better the dispersion, i.e. the better the comminution and distribution, of the fillers in the polymer molding compound needs to be.

### SUMMARY

It is therefore an object of the present invention to provide a process for producing an improved polycarbonate molding compound comprising a reinforcing filler.

In one general aspect, the disclosure provides a process for producing a molding compound comprising the following constituents:
97% to 36% by weight of polycarbonate,
3% to 20% by weight of reinforcing filler,
0% to 61% by weight of other molding compound constituents,
   the sum of the constituents being 100% by weight, and wherein a masterbatch is first produced which comprises the following constituents:
70% to 25% by weight of polycarbonate,
30% to 70% by weight of reinforcing filler,
0% to 5% by weight of other masterbatch constituents,
   the sum of the constituents being 100% by weight, and wherein the masterbatch is compounded in a continuous single-shaft kneader in the following steps:
(1) adding polycarbonate and at least one reinforcing filler to a continuous single-shaft kneader,
(2) compounding the polycarbonate and the at least one reinforcing filler using the continuous single-shaft kneader,
   wherein the proportion of polyester in the masterbatch is not more than 0.9% by weight, and subsequently the following steps are carried out:
(3) adding the masterbatch and polycarbonate to a compounding unit;
(4) compounding the masterbatch and polycarbonate using the compounding unit,
   wherein the reinforcing filler is selected from one or more members of the group made up of titanium dioxide (TiO₂), talc (Mg₃Si₄O₁₀(OH)₂), dolomite (CaMg[CO₃]₂), kaolinite Al₄[(OH)₈|Si₄O₁₀], and wollastonite (Ca₃[Si₃O₉]), preferably selected from one or more members of the group made up of titanium dioxide (TiO₂) and talc (Mg₃Si₄O₁₀(OH)₂), and wherein either the proportion of polyester in the molding compound is not more than 0.9% by weight, or
   the proportion of polyester in the molding compound is not less than 22% by weight and not more than 58% by weight.

The polycarbonate molding compound according to the invention shall in particular have improved surface properties, in particular fewer defects, especially in turn fewer defects in the form of elevations or depressions in the surface brought about by incompletely dispersed particles of reinforcing filler.

### BRIEF DESCRIPTION OF FIGURES

FIG. 1 shows an example of a basic construction of a twin-screw extruder having a housing consisting of 11 parts;

FIG. 1.3 shows an example of a basic construction of a twin-screw extruder having a housing consisting of 9 parts;

FIG. 2 shows an example of a basic construction of a continuous single-shaft kneader having a housing consisting of 3 parts;

FIG. 3 shows a micrograph of titanium dioxide particles on a molding surface and an EDX spectrum thereof;

FIG. 4 shows a micrograph of degraded polycarbonate particles on a molding surface; and

FIG. 5 shows a micrograph of metal-containing particles on a molding surface and an EDX spectrum thereof.

### DETAILED DESCRIPTION

A masterbatch produced according to the invention comprises a polycarbonate and at least one reinforcing filler preferably selected from the group comprising titanium dioxide (TiO₂), talc (Mg₃Si₄O₁₀(OH)₂), dolomite CaMg[CO₃]₂, kaolinite Al₄[(OH)₈|Si₄O₁₀]and wollastonite Ca₃[Si₃O₉], more preferably selected from the group comprising titanium dioxide (TiO₂) and talc (Mg₃Si₄O₁₀(OH)₂). The total content of reinforcing filler in the masterbatch is 30% to 70% by weight, preferably 35% to 65% by weight, more preferably 40% to 60% by weight, in each case based on the total mass of the masterbatch.

A masterbatch produced according to the invention preferably comprises just one reinforcing filler, i.e. just titanium dioxide (TiO₂), or just talc (Mg₃Si₄O₁₀(OH)₂) or just dolomite CaMg[CO₃]₂ or just kaolinite Al₄[(OH)₈|Si₄O₁₀] or just wollastonite Ca₃[Si₃O₉], preferably just titanium dioxide (TiO₂) or just talc (Mg₃Si₄O₁₀(OH)₂). With regard to this one reinforcing filler, the masterbatch used in each case comprises a higher content of reinforcing filler than the respective molding compound produced using said masterbatch.

The total content of reinforcing filler in the molding compound may nevertheless be higher than the total content of reinforcing filler in the masterbatch, particularly when the masterbatch comprises just one reinforcing filler, since the molding compound may comprise multiple reinforcing fillers. The total content of reinforcing filler in the molding compound may be achieved by adding different masterbatches each comprising different reinforcing fillers and/or by additionally adding reinforcing fillers, in particular achieved by additionally adding reinforcing fillers.

The masterbatch is according to the invention obtainable by compounding a polycarbonate, at least one reinforcing filler, and optionally other masterbatch constituents using a continuous single-shaft kneader. In particular, the process according to the invention comprises the following steps:

(1) adding polycarbonate and at least one reinforcing filler to a continuous single-shaft kneader;

(2) compounding the polycarbonate and the at least one reinforcing filler using a continuous single-shaft kneader.

Preferably, just one reinforcing filler is added in step (1). It is also possible for other masterbatch constituents to be added in either step (1) or in step (2) and co-compounded in step (2). Step (1) and step (2) can take place either sequentially or at the same time.

Polycarbonate, reinforcing filler, and optionally other masterbatch constituents may be added to the continuous single-shaft kneader at the same time or sequentially. In particular, the at least one reinforcing filler may be added either before the polycarbonate has melted, after the polycarbonate has melted, or both before and after the polycarbonate has melted.

The masterbatch may additionally comprise other masterbatch constituents. The content of other masterbatch constituents in the masterbatch comprising a polycarbonate and at least one reinforcing filler is from 0% to 5% by weight, preferably from 0% to 4% by weight, more preferably from 0% to 3% by weight, in each case based on the total mass of the molding compound. In accordance with the total content of the at least one reinforcing filler and the content of other masterbatch constituents, the polycarbonate content in the masterbatch according to the invention is 70% to 25% by weight, preferably 65% to 31% by weight, more preferably 59.5% to 37% by weight, in each case based on the total mass of the masterbatch. The sum of all constituents of the masterbatch is 100% by weight.

These other masterbatch constituents include for example other fillers customary for a polycarbonate masterbatch, other thermoplastics, for example acrylonitrile-butadiene-styrene copolymers, styrene-acrylonitrile copolymers or also polyesters, or other additives such as UV stabilizers, IR stabilizers, heat stabilizers, antistats, dyes, and pigments are added in the customary amounts; optionally, the demolding characteristics, flow characteristics and/or flame retardancy may be further improved by adding external demolding agents, flow agents and/or flame retardants (for example alkyl and aryl phosphites, phosphates, and phosphanes, low-molecular-weight carboxylic esters, halogen compounds, salts, chalk, quartz powder, glass fibers, carbon fibers, pigments, and combinations thereof. Such compounds are described for example in WO 99/55772, pp. 15-25, and in “Plastics Additives”, R. Gächter and H. Müller, Hanser Publishers 1983. Preference as stabilizer is given to a carboxylic anhydride-modified alpha-olefin polymer, in particular a maleic anhydride-modified alpha-olefin polymer. Such carboxylic anhydride-modified alpha-olefin polymers are known for example from WO2018037037A1. If the other masterbatch constituents are one or more thermoplastics, the total content thereof in the masterbatch is not more than 3.0% by weight, preferably not more than 2.5% by weight, more preferably not more than 2.0% by weight. A higher proportion of thermoplastics that are not a polycarbonate limits the usability of the masterbatch too much.

A distinction must be made between the abovementioned polyesters and the polyester carbonates described further above. The polyesters are for the purposes of the present invention in particular those described in sections [0131] to [0138] of US 2014/357769 A1. The proportion of polyester in the masterbatch is not more than 0.9% by weight, preferably not more than 0.5% by weight, more preferably not more than 0.2% by weight, particularly preferably not more than 0.1% by weight, very particularly preferably from 0% to 0.1% by weight. Most preferably, the proportion of polyester in the masterbatch is 0% by weight.

Masterbatches are known in principle from the prior art, for example from [1] ([1]=Klemens Kohlgrüber: Der gleichläufige Doppelschneckenextruder [The co-rotating twin-screw extruder], 2nd revised and expanded edition, Hanser Verlag, Munich 2016, p. 76 ff).

For the purposes of the present invention, a masterbatch is understood as meaning a solid mixture comprising at least one polymer and at least one reinforcing filler, wherein a masterbatch may be present in the form of pellets, powder or in another form and may be used in the production of polymer molding compounds.

A masterbatch comprising a polycarbonate is hereinbelow also referred to as a polycarbonate masterbatch.

Also known from the prior art, for example from [1] ([1]=Klemens Kohlgrüber: Der gleichläufige Doppelschneckenextruder [The co-rotating twin-screw extruder], 2nd revised and expanded edition, Hanser Verlag, Munich 2016, p. 47 ff), is the preparation of polymer molding compounds, such as for example also a molding compound comprising a polycarbonate of one of these polymer molding compounds, by admixing additives, for example fillers, such that said polymer molding compounds achieve a desired property profile. This preparation, also referred to as compounding, is generally carried out in a twin-screw extruder. It is in particular desirable to achieve a best-possible dispersion of the fillers in the polymer molding compound, i.e. a best-possible comminution and distribution of the fillers in the polymer molding compound. Compounding becomes increasingly difficult as the total content of fillers to be dispersed in the polymer molding compound rises and the better the dispersion, i.e. the better the comminution and distribution, of the fillers in the polymer molding compound needs to be.

A molding compound comprising a polycarbonate is hereinbelow also referred to as a polycarbonate molding compound.

According to the invention, the at least one reinforcing filler is introduced into the polycarbonate molding compound using the masterbatch produced according to the invention. A polycarbonate molding compound produced in this way comprises a polycarbonate and at least one reinforcing filler. The total content of reinforcing filler is 3% to 20% by weight, preferably 4.5% to 15% by weight, in each case based on the total mass of the molding compound.

The molding compound may also comprise other molding compound constituents. The content of other molding compound constituents in the molding compound comprising a polycarbonate and at least one reinforcing filler is from 0% to 61% by weight, preferably from 0% to 54.5% by weight, more preferably from 0% to 25% by weight, in each case based on the total mass of the molding compound. In accordance with the total content of the at least one reinforcing filler and the content of other molding compound constituents, the polycarbonate content in the molding compound according to the invention is 97% to 36% by weight, preferably 95.5% to 41% by weight, in each case based on the total mass of the molding compound. The sum of all constituents of the molding compound is 100% by weight. It is for example possible—and without the present invention being restricted thereto—for a polycarbonate molding compound according to the invention that contains 15% by weight of reinforcing filler to additionally contain 82% by weight of polycarbonate and 3% by weight of other molding compound constituents, or for a polycarbonate molding compound according to the invention that comprises 15% by weight of reinforcing filler to additionally contain 65% by weight of polycarbonate and 20% by weight of other molding compound constituents.

It is also for example possible—and without the present invention being restricted thereto—for a polycarbonate molding compound according to the invention that contains 4.5% by weight of reinforcing filler to additionally contain 92.5% by weight of polycarbonate and 3% by weight of other molding compound constituents, or for a polycarbonate molding compound according to the invention that comprises 4.5% by weight of reinforcing filler to additionally contain 65.5% by weight of polycarbonate and 30% by weight of other molding compound constituents.

According to the invention, this molding compound may be obtained by further processing the polycarbonate masterbatch obtained in steps (1) and (2) as follows:

(3) adding the polycarbonate masterbatch obtained in step (2) and polycarbonate to a compounding unit;

(4) compounding the polycarbonate masterbatch obtained in step (2) and the polycarbonate using the compounding unit.

Step (3) and step (4) can take place either sequentially or at the same time.

It is optionally possible for additional reinforcing filler to be added in step (3) and co-compounded in step (4). This additional reinforcing filler may be the same as the one present in the masterbatch, or it may be a different reinforcing filler than that present in the masterbatch. The reinforcing filler additionally added in step (3) is preferably a different one than that present in the masterbatch.

It is also optionally possible for other molding compound constituents to be added in step (3) and co-compounded in step (4).

The compounding unit is preferably selected from the group made up of continuous single-shaft kneaders, multishaft extruders, in particular twin-screw extruders or ring extruders, planetary roller extruders, ram kneaders, and internal mixers. The compounding unit is particularly preferably a twin-screw extruder or a ring extruder or a planetary roller extruder, very particularly preferably a co-rotating twin-screw extruder.

Improved dispersion of fillers, in particular reinforcing fillers, in a polymer molding compound also has the effect inter alia that the molding compound has improved properties, in particular improved surface properties.

In order to achieve improved dispersion with the highest possible total content of fillers, in particular reinforcing fillers, for a given twin-screw extruder for example, the energy input into the polymer molding compound must be increased. However, this results in an increase in the temperature of the polymer molding compound during compounding in the twin-screw extruder and the higher the energy input, the greater the increase. This in turn can result in the polymer molding compound suffering thermal damage. This can in turn lead to yellowing of the polymer molding compound, to speckling or other undesired changes in the polymer molding compound.

Since said thermal damage is generally to be avoided, improved dispersion is dispensed with or the total content of fillers, in particular reinforcing fillers, is not increased or both. In rare cases, thermal damage or poorer dispersion, or both, is however also tolerated. It is not however possible in this manner to obtain a polymer molding compound having improved surface properties.

It has also been found that the use of a twin-screw extruder having a length-to-diameter ratio (L/D ratio) larger than that in the twin-screw extruder mentioned in the introduction does not remedy the problem, since even for a twin-screw extruder having a larger L/D ratio the thermal stress on the polymer molding compound becomes undesirably high if the desired improved dispersion is to be achieved at a desired high total content of fillers, in particular reinforcing fillers, because increasing the L/D ratio of a twin-screw extruder with conditions otherwise unchanged causes the temperature of the polymer molding compound which is to be extruded to increase by about 10° C. to 20° C. for an additional length of the twin-screw extruder corresponding to four times the external diameter of a screw element that cleans the inner wall of the twin-screw extruder. A polymer molding compound having improved surface properties thus cannot be obtained in this manner either.

The described problem is also encountered when a polycarbonate molding compound having a high proportion of a reinforcing filler is to be produced by compounding.

It is therefore an object of the present invention to provide a process for producing an improved polycarbonate molding compound comprising a reinforcing filler.

The polycarbonate molding compound according to the invention shall in particular have improved surface properties, in particular fewer defects, especially in turn fewer defects in the form of elevations or depressions in the surface brought about by incompletely dispersed particles of reinforcing filler.

It has surprisingly been found that the object is achieved by a process for the production of a polycarbonate molding compound produced using a polycarbonate masterbatch, wherein this polycarbonate masterbatch comprises a polycarbonate and a reinforcing filler and is compounded using a continuous single-shaft kneader. The total content of reinforcing filler in the polycarbonate masterbatch is here from 30% to 70% by weight, preferably 35% to 65% by weight, more preferably 40% to 60% by weight, in each case based on the total mass of the masterbatch, and the total content of reinforcing filler in the polycarbonate molding compound is 3% to 20% by weight, preferably 4.5% to 15% by weight, in each case based on the total mass of the polycarbonate molding compound.

With regard to this one reinforcing filler, the polycarbonate masterbatch used in each case to produce the polycarbonate molding compound has a higher content of reinforcing filler than the polycarbonate molding compound produced in each case using this polycarbonate masterbatch. The content of the one reinforcing filler in the polycarbonate masterbatch is preferably from 1.2 to 140 times as high, preferably from 1.5 to 100 times as high, more preferably from 2 to 10 times as high, as the content of the one reinforcing filler in the molding compound.

The process according to the invention affords improved polycarbonate molding compounds. Without the inventors wishing to be bound to any particular scientific theory, it can reasonably be assumed that the improved properties of the polycarbonate molding compound produced according to the invention are due to the polycarbonate masterbatch likewise having improved properties, which in turn arise in particular from improved dispersion of the reinforcing filler(s) in the masterbatch.

The means by which the object has been achieved is a particularly surprise, because continuous single-shaft kneaders had not previously been known to have a particular dispersive mixing effect, so their use had not been expected to result in significantly improved dispersion and the improvements resulting therefrom. A dispersive mixture has the feature that particles are not only distributed in a volume, but said particles are in particular comminuted.

For the purposes of the present invention, a reinforcing filler is understood as meaning a mineral filler suitable for increasing the stiffness of the polycarbonate molding compound produced according to the invention. The reinforcing filler is preferably selected from the group comprising titanium dioxide (TiO₂), talc (Mg₃Si₄O₁₀(OH)₂), dolomite CaMg[CO₃]₂, kaolinite Al₄[(OH)₈|Si₄O₁₀], and wollastonite Ca₃[Si₃O₉], preferably selected from the group comprising titanium dioxide (TiO₂) and talc (Mg₃Si₄O₁₀(OH)₂). This applies equally to the masterbatch molding compound and to the polycarbonate molding compound.

In particular, the process according to the invention affords polycarbonate molding compounds having improved surface properties, in particular fewer defects, especially in turn fewer defects in the form of elevations or depressions in the surface brought about by incompletely dispersed particles of reinforcing filler. Incompletely dispersed particles of reinforcing filler may be determined for example by visual analysis of images of molded articles produced from the molding compound according to the invention; the particle size distribution of the incompletely dispersed particles of reinforcing filler may be evaluated by means of a classification.

A polycarbonate molding compound of this kind produced according to the invention has better, i.e. improved, properties compared to polycarbonate molding compounds produced by processes according to the prior art, where the polycarbonate molding compounds produced according to the prior art comprise the same constituents in the same proportions as the polycarbonate molding compound produced according to the invention.

For the purposes of the present invention, the term “molded article” is understood as meaning an article that is the result of further processing of the molding compound. Thus for example not only an article obtainable from the molding compound by injection molding but also a film or sheet obtainable by extrusion of the molding compound are to be considered as molded articles.

The titanium dioxide (TiO₂) employed is preferably the rutile modification having a particle size d₅₀ of 0.1 μm to 5 μm, preferably 0.3 to 3 μm. Examples of titanium dioxide usable according to the invention are selected from the commercially available products Kronos 2230 titanium dioxide and Kronos 2233 titanium dioxide; the manufacturer of both products is Kronos Titan GmbH Leverkusen.

Talc (Mg₃Si₄O₁₀(OH)₂) is preferably employed with a particle size (150 of 0.1 μm to 10 μm, preferably 0.3 to 3 μm. Talcs that may be used include for example the commercially available products Jetfine 3CA from Imerys Talc (Luzenac Europe SAS) or HTP Ultra 5C talc from IMI Fabi S.p.A.

Particle size d₅₀ is in each case based on mass and was determined in accordance with ISO 1333 17-3 using a Sedigraph 5100 from Micrometrics, Germany.

Mixtures of titanium dioxide and talc may be employed in any desired mixture ratios. It is preferable when the mixing ratio of titanium dioxide to talc is 1:60 to 1:1, preferably 1:30 to 1:5, in each case based on mass.

The particles of the respective mineral of which the reinforcing filler consists preferably have an aspect ratio of 1:1 to 1:7.

For the purposes of the present invention, “polycarbonate” is understood as meaning both homopolycarbonates and copolycarbonates. The polycarbonates may be linear or branched in the familiar manner. Also employable according to the invention are mixtures of polycarbonates.

A proportion up to 80 mol %, preferably from 20 mol % up to 50 mol %, of the carbonate groups in the polycarbonates employed according to the invention may have been replaced by preferably aromatic dicarboxylic ester groups. Polycarbonates of this kind that incorporate both acid moieties from the carbonic acid and acid moieties from preferably aromatic dicarboxylic acids into the molecular chain are referred to as aromatic polyester carbonates.

The replacement of the carbonate groups by the aromatic dicarboxylic ester groups occurs essentially stoichiometrically and also quantitatively, which means that the molar ratio of the coreactants is reflected in the finished polyester carbonate too. The aromatic dicarboxylic ester groups may be incorporated either randomly or in blocks.

The thermoplastic polycarbonates including the thermoplastic polyester carbonates have average molecular weights Mw determined by GPC (gel-permeation chromatography in methylene chloride with polycarbonate as standard) of 15 kg/mol to 50 kg/mol, preferably of 20 kg/mol to 35 kg/mol, more preferably of 23 kg/mol to 33 kg/mol.

The preferred aromatic polycarbonates and aromatic polyester carbonates are produced in a known manner from diphenols, carbonic acid or carbonic acid derivatives and, in the case of the polyester carbonates, preferably aromatic dicarboxylic acids or dicarboxylic acid derivatives, optionally chain terminators and branching agents.

Details of the production of poly carbonates have been set out in many patent specifications over the past 40 years or so. Reference may be made here by way of example to Schnell, “Chemistry and Physics of Polycarbonates”, Polymer Reviews, volume 9, Interscience Publishers, New York, London, Sydney 1964, to D. Freitag, U. Grigo, P. R. Müller, H. Nouvertné, Bayer A G, “Polycarbonates” in Encyclopedia of Polymer Science and Engineering, volume 11, second edition, 1988, pages 648-718, and lastly to U. Grigo, K. Kirchner and P. R. Müller “Polycarbonate” [Polycarbonates] in Becker/Braun, Kunststoff-Handbuch [Plastics Handbook], volume 3/1, “Polycarbonate, Polyacetale, Polyester, Celluloseester” [Polycarbonates, polyacetals, polyesters, cellulose esters], Carl Hanser Verlag Munich, Vienna 1992, pages 117-299.

Aromatic polycarbonates and polyester carbonates are produced for example by reacting diphenols with carbonyl halides, preferably phosgene, and/or with aromatic dicarbonyl dihalides, preferably benzenedicarbonyl dihalides, by the interfacial process, optionally with use of chain terminators and optionally with use of trifunctional or more than trifunctional branching agents, production of polyester carbonates being achieved by replacing some of the carbonic acid derivatives with aromatic dicarboxylic acids or derivatives of dicarboxylic acids, specifically with aromatic dicarboxylic ester structural units according to the proportion of carbonate structural units to be replaced in the aromatic polycarbonates. Production via a melt polymerization process by reaction of diphenols with for example diphenyl carbonate is likewise possible.

Dihydroxyaryl compounds suitable for producing polycarbonates are those of formula (1)

HO—Z—OH (1),

in which

Z is an aromatic radical that has 6 to 30 carbon atoms and may contain one or more aromatic rings, may be substituted, and may contain aliphatic or cycloaliphatic radicals or alkylaryls or heteroatoms as bridging elements.

Z in formula (1) preferably represents a radical of formula (2)

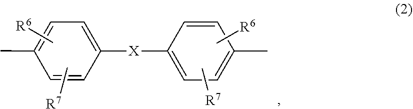

in which

R6 and R7 independently represent H, C1 to C18 alkyl, C1 to C18 alkoxy, halogen such as C1 or Br or in each case optionally substituted aryl or aralkyl, preferably H or C1 to C12 alkyl, particularly preferably H or C1 to C8 alkyl, and very particularly preferably H or methyl, and

X represents a single bond, —SO2-, —CO—, —O—, —S—, C1- to C6 alkylene, C2 to C5 alkylidene or C5 to C6 cycloalkylidene, which may be substituted by C1 to C6 alkyl, preferably methyl or ethyl, or else represents C6 to C12 arylene, which may optionally be fused to further aromatic rings containing heteroatoms.

It is preferable when X represents a single bond, C1 to C5 alkylene, C2 to C5 alkylidene, C5 to C6 cycloalkylidene, —O—, —SO—, —CO—, —S—, —SO2-

or a radical of formula (2a)

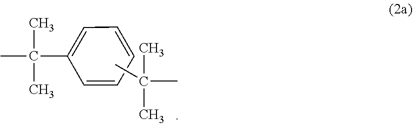

Examples of diphenols suitable for production of the polycarbonates include hydroquinone, resorcinol, dihydroxydiphenyls, bis(hydroxyphenyl)alkanes, bis(hydroxyphenyl)cycloalkanes, bis(hydroxyphenyl) sulfides, bis(hydroxyphenyl) ethers, bis(hydroxyphenyl) ketones, bis(hydroxyphenyl) sulfones, bis(hydroxyphenyl) sulfoxides, α,α′-bis(hydroxyphenyl)diisopropylbenzenes, phthalimidines derived from derivatives of isatin or of phenolphthalein and the ring-alkylated, ring-arylated, and ring-halogenated compounds thereof.

Preferred bisphenols are 4,4′-dihydroxydiphenyl, 2,2-bis(4-hydroxyphenyl)-1-phenylpropane, 1,1-bis(4-hydroxyphenyl)phenylethane, 2,2-bis(4-hydroxyphenyl)propane (bisphenol A (BPA)), 2,4-bis(4-hydroxyphenyl)-2-methylbutane, 1,3-bis[2-(4-hydroxyphenyl)-2-propyl]benzene (bisphenol M), 2,2-bis(3-methyl-4-hydroxyphenyl)propane, bis(3,5-dimethyl-4-hydroxyphenyl)methane , 2,2-bis(3,5-dimethyl-4-hydroxyphenyl)propane , bis(3,5-dimethyl-4-hydroxyphenyl) sulfone, 2,4-bis(3,5-dimethyl-4-hydroxyphenyl)-2-methylbutane, 1,3-bis[2-(3,5-dimethyl-4-hydroxyphenyl)-2-propyl]benzene, 1,1-bis(4-hydroxyphenyl)cyclohexane, and 1,1-bis(4-hydroxyphenyl)-3,3,5-trimethylcyclohexane (bisphenol TMC (BPTMC)), and also the bisphenols of formulas (IV) to (VI)

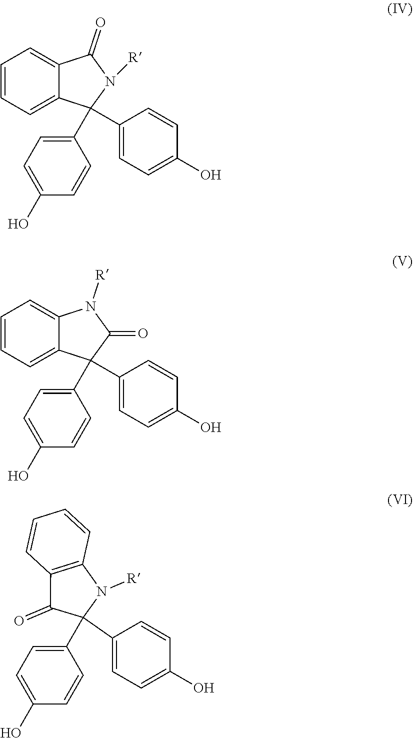

where R′ in each case represents C₁ to C₄ alkyl, aralkyl or aryl, preferably methyl or phenyl.

Particularly preferred bisphenols are 4,4′-dihydroxydiphenyl, 1,1-bis(4-hydroxyphenyl)phenylethane, 2,2-bis(4-hydroxyphenyl)propane (bisphenol A (BPA)), 2,2-bis(3,5-dimethyl-4-hydroxyphenyl)propane, 1,1-bis(4-hydroxyphenyl)cyclohexane and 1,1-bis(4-hydroxyphenyl)-3,3,5-trimethylcyclohexane (bisphenol TMC (BPTMC)), and the dihydroxy compounds of formulas (IV), (V), and (VI), where R′ in each case represents C₁ to C₄ alkyl, aralkyl or aryl, preferably methyl or phenyl.

These and other suitable diphenols are described for example in U.S. Pat. Nos. 3,028,635, 2,999,825, 3,148,172, 2,991,273, 3,271,367, 4,982,014, and 2,999,846, in DE-A 1 570 703, DE-A 2 063 050, DE-A 2 036 052, DE-A 2 211 956, and DE-A 3 832 396, in FR-A 1 561 518, in the monograph “H. Schnell, Chemistry and Physics of Polycarbonates, Interscience Publishers, New York 1964” and also in JP-A 62039/1986, JP-A 62040/1986, and JP A 105550/1986.

In the case of homopolycarbonates only one diphenol is employed and in the case of copolycarbonates two or more diphenols are employed. The diphenols used, like all other chemicals and auxiliaries added to the synthesis, may be contaminated with the impurities from their own synthesis, handling, and storage. It is however desirable to use raw materials of the highest possible purity.

In particular, the polycarbonates according to the invention are composed only of atoms selected from one or more of the elements carbon (C), hydrogen (H), oxygen (O), nitrogen (N), sulfur (S), chlorine (Cl), and bromine (Br).

Polycarbonate-polyorganosiloxane copolymers are preferably excluded as copolycarbonates.

Examples of suitable carbonic acid derivatives are phosgene or diphenyl carbonate.

Suitable chain terminators that may be employed in the production of the polycarbonates are monophenols. Examples of suitable monophenols include phenol itself, alkylphenols such as cresols, p-tert-butylphenol, cumylphenol, and also mixtures thereof.

Preferred chain terminators are the phenols that are monosubstituted or polysubstituted by linear or branched, preferably unsubstituted C1 to C30 alkyl radicals or by tert-butyl. Particularly preferred chain terminators are phenol, cumylphenol and/or p-tert-butylphenol.

The amount of chain terminator to be employed is preferably 0.1 to 5 mol % based on moles of diphenols employed in each case. The chain terminators may be added before, during or after the reaction with a carbonic acid derivative.

Suitable branching agents are the trifunctional or more than trifunctional compounds known in polycarbonate chemistry, in particular those having three or more than three phenolic OH groups.

Examples of suitable branching agents are 1,3,5-tri(4-hydroxyphenyl)benzene, 1,1,1-tri(4-hydroxyphenyl)ethane, tri(4-hydroxyphenyl)phenylmethane, 2,4-bis(4-hydroxyphenylisopropyl)phenol, 2,6-bis(2-hydroxy-5′-methylbenzyl)-4-methylphenol, 2-(4-hydroxyphenyl)-2-(2,4-dihydroxyphenyl)propane, tetra(4-hydroxyphenyl)methane, tetra(4-(4-hydroxyphenylisopropyl)phenoxy)methane, 1,4-bis((4′,4″-dihydroxytriphenyl)methyl)benzene, and 3,3-bis(3-methyl-4-hydroxyphenyl)-2-oxo-2,3-dihydroindole.

The amount of the branching agents for optional use is preferably from 0.05 mol % to 2.00 mol % based on moles of diphenols employed in each case.

The branching agents may either be initially charged together with the diphenols and the chain terminators in the aqueous alkaline phase or be added as a solution in an organic solvent before the phosgenation. In the case of the transesterification process, the branching agents are employed together with the diphenols.

Particularly preferred polycarbonates are the homopolycarbonate based on bisphenol A, the homopolycarbonate based on 1,3-bis(4-hydroxyphenyl)-3,3,5-trimethylcyclohexane, and the copolycarbonates based on the monomer bisphenol A on one side and a monomer selected from the group comprising 1,1-bis(4-hydroxyphenyl)-3,3,5-trimethylcyclohexane and the bisphenols of formulas (IV) to (VI)

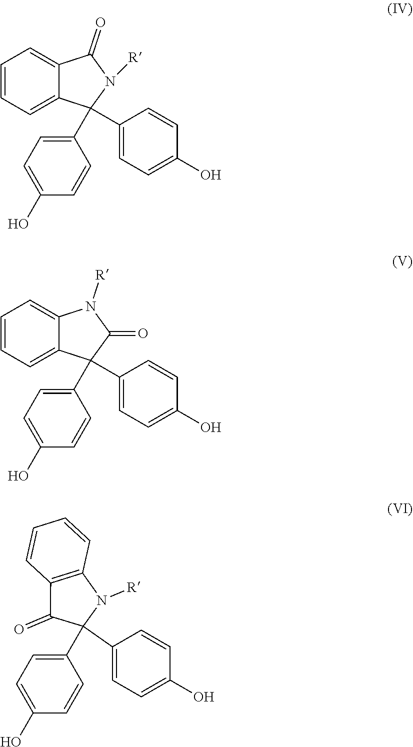

where R′ in each case represents C₁ to C₄ alkyl, aralkyl or aryl, preferably methyl or phenyl on the other side.

Preferred ways of producing the polycarbonates to be used according to the invention, including the polyester carbonates, are the known interfacial process and the known melt transesterification process (cf. e.g. WO 2004/063249 A1, WO 2001/05866 A1, WO 2000/105867, U.S. Pat. Nos. 5,340,905 A, 5,097,002 A, 5,717,057 A).

Most preferred as the polycarbonate is aromatic polycarbonate based on bisphenol A.

Besides titanium dioxide (TiO₂) and/or talc (Mg₃Si₄O₁₀(OH)₂), dolomite CaMg[CO₃]₂, kaolinite Al₄[(OH)₈|Si₄O₁₀] and/or wollastonite Ca₃[Si₃O₉], it is also possible to add further molding compound constituents to the polycarbonate molding compound according to the invention.

The content of other molding compound constituents in the polycarbonate molding compound produced according to the invention is from 0% to 37% by weight, preferably from 0% to 20% by weight, more preferably 0% to 10% by weight.

These other molding compound constituents include for example other fillers customary for polycarbonate molding compounds, other thermoplastics, for example acrylonitrile-butadiene-styrene copolymers, styrene-acrylonitrile copolymers or also polyesters, or other additives such as UV stabilizers, IR stabilizers, heat stabilizers, antistats, dyes, and pigments are added in the customary amounts; optionally, the demolding characteristics, flow characteristics and/or flame retardancy may be further improved by adding external demolding agents, flow agents and/or flame retardants (for example alkyl and aryl phosphites, phosphates, and phosphanes, low-molecular-weight carboxylic esters, halogen compounds, salts, chalk, quartz powder, glass fibers, carbon fibers, pigments, and combinations thereof. Such compounds are described for example in WO 99/55772, pp. 15-25, and in “Plastics Additives”, R. Gächter and H. Müller, Hanser Publishers 1983. Preference as stabilizer is given to a carboxylic anhydride-modified alpha-olefin polymer, in particular a maleic anhydride-modified alpha-olefin polymer. Such carboxylic anhydride-modified alpha-olefin polymers are known for example from WO2018037037A1.

A distinction must be made between the abovementioned polyesters and the polyester carbonates described further above. The polyesters are for the purposes of the present invention in particular those described in sections [0131] to [0138] of US 2014/357769 A1.

The proportion of polyester in the molding compound is not more than 0.9% by weight, preferably not more than 0.5% by weight, more preferably not more than 0.2% by weight, particularly preferably not more than 0.1% by weight, very particularly preferably from 0% to 0.1% by weight. Most preferably, the proportion of polyester in the molding compound is 0% by weight.

In one alternative according to the invention, the proportion of polyester in the molding compound is not less than 22% by weight to not more than 58% by weight, preferably not less than 23% by weight to not more than 55% by weight, more preferably not less than 25% by weight to not more than 50% by weight.

Suitable additives are described for example in “Additives for Plastics Handbook, John Murphy, Elsevier, Oxford 1999”, in the “Plastics Additives Handbook, Hans Zweifel, Hanser, Munich 2001”.

Examples of suitable antioxidants/thermal stabilizers include:

alkylated monophenols, alkylthiomethylphenols, hydroquinones and alkylated hydroquinones, tocopherols, hydroxylated thiodiphenyl ethers, alkylidenebisphenols, O—, N— and S-benzyl compounds, hydroxybenzylated malonates, aromatic hydroxybenzyl compounds, triazine compounds, acylaminophenols, esters of β-(3,5-di-tert-butyl-4-hydroxyphenyl)propionic acid, esters of β-(5-tert-butyl-4-hydroxy-3-methylphenyl)propionic acid, esters of β-(3,5-dicyclohexyl-4-hydroxyphenyl)propionic acid, esters of 3,5-di-tert-butyl-4-hydroxyphenylacetic acid, amides of β-(3,5-di-tert-butyl-4-hydroxyphenyl)propionic acid, suitable thio synergists, secondary antioxidants, phosphites and phosphonites, benzofuranones, and indolinones.

Preference is given to organic phosphites, phosphonates, and phosphanes, mostly those in which the organic radicals consist completely or partially of optionally substituted aromatic radicals.

Suitable complexing agents for heavy metals and for the neutralization of traces of alkalis are ortho- and metaphosphoric acids, fully or partly esterified phosphates or phosphites.

Suitable light stabilizers (UV absorbers) are 2-(2′-hydroxyphenyl)benzotriazoles, 2-hydroxybenzophenones, esters of substituted and unsubstituted benzoic acids, acrylates, sterically hindered amines, oxamides and also 2-(hydroxyphenyl)-1,3,5-triazines and substituted hydroxyalkoxyphenyl-1,3,5-triazoles, preference being given to substituted benzotriazoles, for example 2-(2′-hydroxy-5′-methylphenyl)benzotriazole, 2-(2′-hydroxy-3′,5′-di-t-butylphenyl)benzotriazole, 2-(2′-hydroxy-3′-tert-butyl-5′-methylphenyl)-5-chlorobenzotriazole, 2-(2′-hydroxy-3′,5′-tert-butylphenyl)-5-chlorobenzotriazole , 2-(2′-hydroxy-5′-tert-octylphenyl)benzotriazole, 2-(2′-hydroxy-3′,5′-di-tert-amylphenyl)benzotriazole , 2-[2′-hydroxy-3′-(3″,4″,5″,6″-tetrahydrophthalimidoethyl)-5′-methylphenyl]benzotriazole, and 2,2′-methylenebis[4-(1,1,3,3-tetramethylbutyl)-6-(2H-benzotriazol-2-yl)phenol].

Polypropylene glycols, alone or in combination with, for example, sulfones or sulfonamides as stabilizers, may be used to counteract damage by gamma rays.

These and other stabilizers may be used individually or in combinations and may be added to the polycarbonate in the recited forms.

It is also possible to add processing aids such as demolding agents, mostly derivatives of long-chain fatty acids. Preference is given for example to pentaerythritol tetrastearate and glycerol monostearate. Said demolding agents are employed on their own or as mixtures.

Suitable flame retardant additives are phosphate esters, i.e. triphenyl phosphate, resorcinol diphosphate, brominated compounds, such as brominated phosphoric esters, brominated oligocarbonates and polycarbonates, and preferably salts of fluorinated organic sulfonic acids.

Suitable impact modifiers are butadiene rubber with grafted-on styrene-acrylonitrile or methyl methacrylate, ethylene-propylene rubbers with grafted-on maleic anhydride, ethyl and butyl acrylate rubbers with grafted-on methyl methacrylate or styrene-acrylonitrile, interpenetrating siloxane and acrylate networks with grafted-on methyl methacrylate or styrene-acrylonitrile.

In addition, it is possible to add colorants such as organic dyes or pigments or inorganic pigments, IR absorbers, individually, as mixtures or else in combination with stabilizers, glass fibers, (hollow) glass beads, and inorganic, in particular mineral, fillers, these mineral fillers also including reinforcing fillers, especially titanium dioxide (TiO₂), talc (Mg₃Si₄O₁₀(OH)₂), dolomite CaMg[CO₃]₂, kaolinite Al₄[(OH)₈|Si₄O₁₀], and wollastonite Ca₃[Si₃O₉], very especially titanium dioxide (TiO₂) and talc (Mg₃Si₄O₁₀(OH)₂).

The polycarbonate molding compound according to the invention, optionally in admixture with other thermoplastics and/or customary additives, may be employed anywhere where already known polycarbonate molding compounds are employed.

A continuous single-shaft kneader has a single rotating screw shaft that executes an axial reciprocating movement synchronously with rotation, this resulting in an oscillating movement, in particular a sinusoidal oscillating reciprocating movement. The maximum length of the path in the axial direction that the screw shaft covers during the forward movement or in the return movement is also termed the stroke, the length of the path that the screw shaft covers during the forward movement being equal to the length of the path that the screw shaft covers during the return movement.

Located on the screw shaft of a continuous single-shaft kneader is a screw set having a screw profile similar to the profile of the screw of a single-shaft extruder, as is customarily employed for the extrusion of plastic molding compounds, but with the difference that the screw elements in the major part of the continuous single-shaft kneader are interrupted and thus subdivided so that so-called kneading blades are formed. The screw set of a continuous single-shaft kneader consist of screw elements that may be arranged in modular fashion on the screw shaft. The screw elements may have different lengths and also kneading blade profiles having different geometries and pitches. Both 3- and 4-blade screw elements may be used.

Located in the housing surrounding the screw shaft are kneading pins, which are fixed in position. Usually there are 3 rows (3-blade) or 4 rows (4-blade) of kneading pins along the housing of the continuous single-shaft kneader. The kneading pins may for example be round or diamond-shaped in cross section and have varying lengths and cross-sectional areas.

The housing and the screw shaft of the continuous single-shaft kneader may be designed to be both heatable and coolable.

The external diameter of a screw element is also referred to as DE. The core radius of a screw element is referred to as DI.

For the purposes of the present invention, the L/D ratio is the ratio of the length of the section of the screw shaft that is fitted with screw elements and the external diameter of a screw element.

For discharge of the melt from the continuous single-shaft kneader, for example via a die plate, it is customary to use a separate discharge element, since the continuous single-shaft kneader itself cannot generate sufficient pressure to get past the die plate. The discharge element may be for example a single-shaft extruder, a twin-shaft extruder or a melt pump. These discharge elements are located downstream of the continuous single-shaft kneader, preferably immediately downstream of the continuous single-shaft kneader, but possibly also separated therefrom by a chute or a flange.

Continuous single-shaft kneaders in and of themselves are known for example from:

DE1908414A1, DD71190A, and from the book “Einführung in die Kunststoffverarbeitung” [Introduction to plastics processing], Carl Hanser Verlag, Munich, 8th edition, 2017, pages 104-105, the publication “Der Ko-Kneter in der Plastik-Industrie” [The co-kneader in the plastics industry] in the journal Schweizer Maschinenmarkt, 1960, pages 54-61, and the book “Mixing in polymer processing”, Marcel Dekker Inc., 1991, pages 200-219.

It is also known, for example from the book “Einführung in die Kunststoffverarbeitung” [Introduction to plastics processing], Carl Hanser Verlag, Munich, 8th edition, 2017, pages 104-105 and the book “Mixing in polymer processing”, Marcel Dekker Inc., 1991, pages 200-219, that continuous single-shaft kneaders produce a good distributive mixing effect.

However, it is not disclosed in the prior art that an improved dispersive mixture can be achieved with a continuous single-shaft kneader, that is to say a mixture in which particles are not only distributed in a volume, but said particles are in addition further comminuted. Neither is it disclosed anywhere in the prior art that it is possible with a continuous single-shaft kneader to produce a polycarbonate masterbatch with which it is possible to produce a polycarbonate molding compound that comprises a reinforcing filler and has improved properties. In particular, nowhere in the prior art is disclosed a process for producing a polycarbonate molding compound comprising a reinforcing filler, wherein the total content of reinforcing filler is 3% to 20% by weight, preferably 4.5% to 15% by weight, in each case based on the total mass of the polycarbonate molding compound, and wherein the polycarbonate molding compound is produced using a polycarbonate masterbatch that is in turn produced using a continuous single-shaft kneader, and wherein this polycarbonate masterbatch has a total content of reinforcing filler of 30% to 70% by weight, preferably 35% to 65% by weight, more preferably 40% to 60% by weight, in each case based on the total mass of the masterbatch. The reinforcing filler is in each case preferably selected from the group comprising titanium dioxide (TiO₂), talc (Mg₃Si₄O₁₀(OH)₂), dolomite CaMg[CO₃]₂, kaolinite Al₄[(OH)₈|Si₄O₁₀] and wollastonite Ca₃[Si₃O₉], preferably selected from the group comprising titanium dioxide (TiO₂) and talc (Mg₃Si₄O₁₀(OH)₂).

A polycarbonate molding compound of this kind produced according to the invention has better properties compared to polycarbonate molding compounds produced by processes according to the prior art where the polycarbonate molding compounds produced according to the prior art comprise the same constituents in the same proportions as the polycarbonate molding compound produced according to the invention.

It is preferable according to the invention when the polycarbonate masterbatch is produced using a continuous single-shaft kneader having a DE/stroke ratio of 4 to 7, more preferably of 5.5 to 6.7.

It is further preferable according to the invention when the continuous single-shaft kneader has an L/D ratio of 10 to 25.

It is further preferable according to the invention when the continuous single-shaft kneader has a DE/DI ratio of 1.5 to 1.8, more preferably of 1.55 to 1.71.

It is further preferable according to the invention when the screw elements of the continuous single-shaft kneader have an external diameter DE of 30 to 200 mm.

It is further preferable according to the invention when the continuous single-shaft kneader has a flight depth defined as (DE−DI)/2 of 5 to 92 mm.

The continuous single-shaft kneader employed according to the invention may be for example a Buss co-kneader produced under the Mx or MKS or MDK names by Buss AG (Switzerland) or else a single-shaft kneader produced under the SJW name by Xinda (China) or a single-shaft kneader produced under the CK name by X-Compound (Switzerland).

The present invention further provides a masterbatch produced by the process according to the invention.

The present invention further provides a molding compound produced by the process according to the invention.

The molding compound according to the invention is also characterized in that, after cooling, it can be used for injection molding without further processing.

The invention also provides for the use of the molding compound according to the invention for production of a molded article, in particular of an article obtainable by injection molding or of a film or sheet obtainable by extrusion of the molding compound or of a profile, or of a reflector for a light or of a structural component, for example for automobile construction. The good surface properties of the molding compound allow the molded article produced therefrom to readily undergo electroplating or metal vapor deposition.

The invention is elucidated hereinbelow with reference to examples, without any intention that the invention be limited to these examples.

### COMPARATIVE EXAMPLES

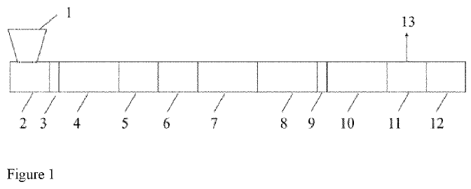

The experiment described in comparative example 1 was carried out using a ZSK92 Mc+ twin-screw extruder from Coperion GmbH. The twin-screw extruder used has a housing internal diameter of 93 mm and an L/D ratio of 36. The basic construction of the extruder used is shown in FIG. 1.3. The twin-screw extruder has a housing consisting of 9 parts in which 2 co-rotating, intermeshing shafts (not shown) are arranged.

In example 1, the metered addition of all constituents of the polycarbonate molding compound took place via the main intake in housing 49, via the depicted feed hopper 48.

Located in the region of housings 49 to 52 is a conveying zone for a polycarbonate pellet material, a titanium dioxide powder, and the other molding compound constituents.

Located in the region of housings 52 to 54 is a plasticizing zone consisting of various two- and three-flight kneading blocks of various widths and also toothed mixing elements.

Located in the region of housings 54 to 55 is a mixing zone consisting of kneading elements, toothed mixing elements, and conveying elements.

Located in housing part 56 is side vent 58, which is connected to a twin-shaft side-vented extruder (not shown) and an extraction apparatus (not shown) connected thereto.

Located in housing 57 is the pressurization zone and downstream thereof a melt filtration in the form of a K-SWE-250 double-piston screen changer from Kreyenborg GmbH. Located in each of the two screen cavities of the double-piston screen changer is a breaker plate and a 4-ply melt filter pack consisting of square-mesh fabrics in linen weave with the mesh sizes 315/200/315/800 μm. Following downstream of the screen changer is a start-up valve from Trendelkamp GmbH (not shown) and an EAC-7 underwater pelletizer from Gala with a die plate having 100 holes (not shown).

In example 1, polycarbonate pellet material and a powder mixture comprising titanium dioxide powder were metered into feed hopper 48 by means of commercially available gravimetric differential weigh feeders.

Pelletization was in example 1 carried out in the form of underwater pelletization.

The melt temperature was in example 1 measured by means of a thermocouple screwed into the housing of the start-up valve.

The experiments described in comparative examples 3 and 5 were carried out using a ZE60A UTXi twin-screw extruder from KraussMaffei Berstorff GmbH. The twin-screw extruder used has a housing internal diameter of 65 mm and an L/D ratio of 43. The basic construction of the extruder used is shown in FIG. 1. The twin-screw extruder has a housing consisting of 11 parts in which 2 co-rotating, intermeshing shafts (not shown) are arranged.

In examples 3 and 5, the metered addition of all constituents of the polycarbonate molding compound took place via the main intake in housing 2, via the depicted feed hopper 1.

Located in the region of housings 2 to 7 is a conveying zone for a polycarbonate pellet material, a titanium dioxide powder, and the other molding compound constituents.

Located in the region of housing 8 is a plasticizing zone consisting of various two- and three-flight kneading blocks of various widths and also toothed blocks.

Located in the region of housings 9 to 10 is a mixing zone consisting of kneading elements, toothed blocks, and conveying elements.

Located in housing part 11 is vent 13 which is connected to an extraction apparatus (not shown).

Located in housing 12 is the pressurization zone and downstream thereof a die plate having 29 holes.

In examples 3 and 5, polycarbonate pellet material and a powder mixture comprising titanium dioxide powder were metered into feed hopper 1 by means of commercially available gravimetric differential weigh feeders. In addition, further titanium dioxide powder was metered into feed hopper 1 via a separate commercially available gravimetric differential weigh feeder.

Pelletization was in examples 3 and 5 carried out in the form of strand pelletization after water-bath cooling.

The melt temperature was in examples 3 and 5 measured by inserting a thermocouple into the issuing melt of the central melt strand directly upstream of the die plate.

### EXAMPLES ACCORDING TO THE INVENTION

In examples 2.1 and 2.1.1 according to the invention, a polycarbonate masterbatch comprising titanium dioxide was first produced using a Ko-Kneter Mx 58 continuous single-shaft kneader from Buss AG. A polycarbonate molding compound having improved properties was then produced from this polycarbonate masterbatch, polycarbonate, and other molding compound constituents using a ZSK92 Mc+ twin-screw extruder from Coperion GmbH.

The co-kneader used in example 2.1 for production of the polycarbonate masterbatch according to the invention has a housing internal diameter of 58.4 mm, a screw element external diameter DE of 57.7 mm in the region of bearings, a screw element external diameter DE of 56.3 mm in the region outside the bearings, an L/D ratio of 15, a DE/DI ratio of 1.55 from the start of the co-kneader shaft up to the restrictor ring at the end of the melting zone, a DE/DI ratio of 1.71 from the restrictor ring up to the end of the co-kneader shaft, and a DE/stroke ratio of 5.5. The total length of the regions of the bearings is approx. 15% of the total length of the screw shaft of the continuous single-shaft kneader. The region from the start of the co-kneader shaft up to the restrictor ring amounts to 40% of the total length of the co-kneader shaft.

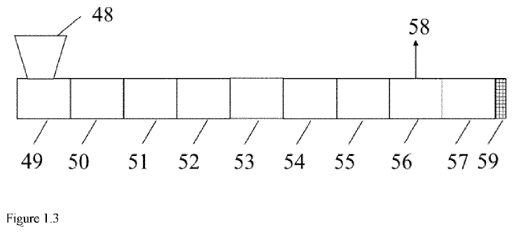

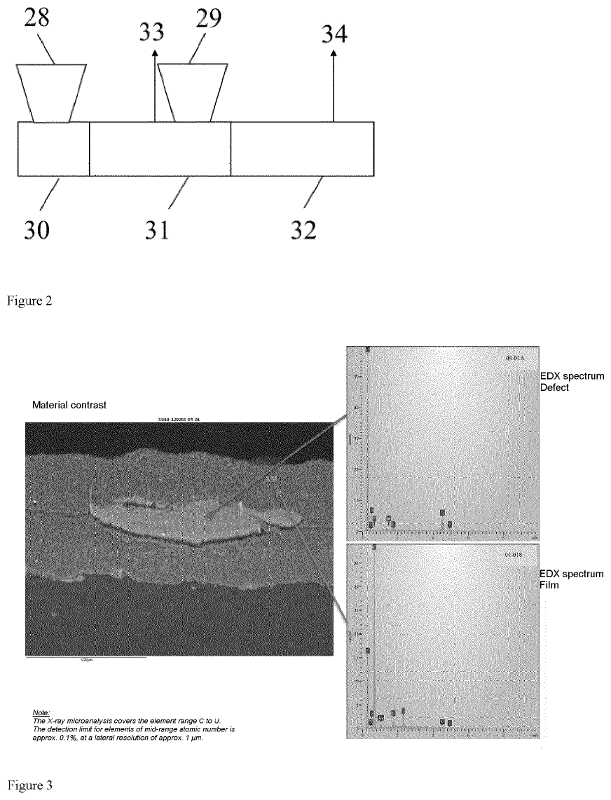

The basic construction of the continuous single-shaft kneader used is shown in FIG. 2. The continuous single-shaft kneader has a housing consisting of 3 parts, in which a rotating and simultaneously axially reciprocating screw shaft (not shown) is arranged.

The melt is discharged from the continuous single-shaft kneader by means of a single-screw extruder (not shown in FIG. 2) having a housing internal diameter of 110 mm and an L/D ratio of 6. The single-screw extruder is flanged directly onto the continuous single-shaft kneader, its sole purpose being for pressurization in the pelletization of the polycarbonate molding compound. No significant mixing and/or comminution of the molding compound constituents takes place in the single-screw extruder. Located at the end of the single-screw extruder is a die plate having a diameter of 118.5 mm for the forming of the melt strands. The die plate contains 66 holes, each 3 mm in diameter, for discharging the melt. The melt strands issuing from the die plate were pelletized by hot-cut pelletization, i.e. the melt strands were chopped off by rotating knives in a flow of water.

In example 2.1 according to the invention for production of a polycarbonate masterbatch, the titanium dioxide powder was metered into housing 31 via the depicted feed hopper 29. The polycarbonate and the other masterbatch constituents were fed to the continuous single-shaft kneader in housing 30 via feed hopper 28.

Located in the region of housing 30 is a conveying zone consisting of conveying elements for a polycarbonate pellet material and the other masterbatch constituents.

Located in the region of housing 31 is a plasticizing zone consisting of various mixing and kneading elements. Located at the end of the plasticizing zone directly upstream of vent 33 is a restrictor ring having an internal diameter of 43 mm. Additionally located at the end of housing 31 is a conveying zone for titanium dioxide powder consisting of conveying elements.

Located in the region of housing 32 is a conveying zone consisting of conveying elements and two mixing zones consisting of various mixing and kneading elements; one at the start and one at the end of the housing. Additionally located in housing 32 between the mixing zones is a devolatilization zone consisting of conveying elements.

Located in housing part 32 is vent 34 which is connected to an extraction apparatus (not shown).

The production of the polycarbonate molding compound according to the invention in example 2.1.1 was carried out using a ZSK92 Mc+ twin-screw extruder from Coperion GmbH. The twin-screw extruder used has a housing internal diameter of 93 mm and an L/D ratio of 36. The twin-screw extruder has a housing consisting of 9 parts in which 2 co-rotating, intermeshing shafts (not shown) are arranged. The basic construction of the extruder used is shown in FIG. 1.3.

In example 2.1.1, the metered addition of all constituents of the polycarbonate molding compound took place via the main intake in housing 49, via the depicted feed hopper 48.

Located in the region of housings 49 to 52 is a conveying zone for a polycarbonate pellet material, a polycarbonate masterbatch, and the other molding compound constituents.

Located in the region of housings 52 to 54 is a plasticizing zone consisting of various two- and three-flight kneading blocks of various widths and also toothed mixing elements.

Located in the region of housings 54 to 55 is a mixing zone consisting of kneading elements, toothed mixing elements, and conveying elements.

Located in housing part 56 is side vent 58, which is connected to a twin-shaft side-vented extruder (not shown) and an extraction apparatus (not shown) connected thereto.

Located in housing 57 is the pressurization zone and downstream thereof a melt filtration in the form of a K-SWE-250 double-piston screen changer from Kreyenborg GmbH. Located in each of the two screen cavities of the double-piston screen changer is a breaker plate and a 4-ply melt filter pack consisting of square-mesh fabrics in linen weave with the mesh sizes 315/200/315/800 μm. Following downstream of the screen changer is a start-up valve from Trendelkamp GmbH (not shown) and an EAC-7 underwater pelletizer from Gala with a die plate having 100 holes (not shown).

In example 2.1.1 according to the invention, polycarbonate pellet material, a powder mixture, and the polycarbonate masterbatch produced in example 2.1 according to the invention were metered into feed hopper 48 by means of commercially available gravimetric differential weigh feeders.

Pelletization was in example 2.1.1 carried out in the form of underwater pelletization.

The melt temperature was in example 2.1.1 measured by means of a thermocouple screwed into the housing of the start-up valve.

In examples 4.1, 4.1.1 and 6.1 according to the invention, a polycarbonate masterbatch comprising titanium dioxide was first produced using a Ko-Kneter Mx 58 continuous single-shaft kneader from Buss AG. A polycarbonate molding compound having improved properties was then produced from this polycarbonate masterbatch, polycarbonate, and other molding compound constituents using a ZE60A UTXi twin-screw extruder from KraussMaffei Berstorff GmbH.

The co-kneader used for production of the polycarbonate masterbatch has a housing internal diameter of 58.4 mm, a screw element external diameter DE of 57.7 mm in the region of bearings, a screw element external diameter DE of 56.3 mm in the region outside the bearings, an L/D ratio of 15, a DE/DI ratio of 1.55 from the start of the co-kneader shaft up to the restrictor ring at the end of the melting zone, a DE/DI ratio of 1.71 from the restrictor ring up to the end of the co-kneader shaft, and a DE/stroke ratio of 5.5. The total length of the regions of the bearings is approx. 15% of the total length of the screw shaft of the continuous single-shaft kneader. The region from the start of the co-kneader shaft up to the restrictor ring amounts to 40% of the total length of the co-kneader shaft.

The basic construction of the continuous single-shaft kneader used is shown in FIG. 2. The continuous single-shaft kneader has a housing consisting of 3 parts, in which a rotating and simultaneously axially reciprocating screw shaft (not shown) is arranged.

The melt is discharged from the continuous single-shaft kneader by means of a single-screw extruder (not shown in FIG. 2) having a housing internal diameter of 110 mm and an L/D ratio of 6. The single-screw extruder is flanged directly onto the continuous single-shaft kneader, its sole purpose being for pressurization in the pelletization of the polycarbonate molding compound. No significant mixing and/or comminution of the molding compound constituents takes place in the single-screw extruder. Located at the end of the single-screw extruder is a die plate having a diameter of 118.5 mm for the forming of the melt strands. The die plate contains 66 holes, each 3 mm in diameter, for discharging the melt. The melt strands issuing from the die plate were pelletized by hot-cut pelletization, i.e. the melt strands were chopped off by rotating knives in a flow of water.

In examples 4.1 and 6 according to the invention for production of the poly carbonate masterbatch according to the invention, the titanium dioxide powder was metered into housing 31 via the depicted feed hopper 29. The polycarbonate and the other masterbatch constituents were fed to the continuous single-shaft kneader in housing 30 via feed hopper 28.

Located in the region of housing 30 is a conveying zone consisting of conveying elements for a polycarbonate pellet material and the other masterbatch constituents.

Located in the region of housing 31 is a plasticizing zone consisting of various mixing and kneading elements. Located at the end of the plasticizing zone directly upstream of vent 33 is a restrictor ring having an internal diameter of 43 mm. Additionally located at the end of housing 31 is a conveying zone for titanium dioxide powder consisting of conveying elements.

Located in the region of housing 32 is a conveying zone consisting of conveying elements and two mixing zones consisting of various mixing and kneading elements; one at the start and one at the end of the housing. Additionally located in housing 32 between the mixing zones is a devolatilization zone consisting of conveying elements.

Located in housing part 32 is vent 34 which is connected to an extraction apparatus (not shown).

The production of the polycarbonate molding compounds according to the invention in examples 4.1.1 and 6.1 was carried out using a ZE60A UTXi twin-screw extruder from KraussMaffei Berstorff GmbH. The twin-screw extruder has a housing internal diameter of 65 mm and an L/D ratio of 43. The basic construction of the extruder used for examples 4.1.1 and 6.1 is shown in FIG. 1.

In examples 4.1.1 and 6.1, the metered addition of all constituents of the polycarbonate molding compound took place via the main intake in housing 2, via the depicted feed hopper 1.

Located in the region of housings 2 to 7 is a conveying zone for a polycarbonate pellet material, a polycarbonate masterbatch, and the other molding compound constituents.

Located in the region of housing 8 is a plasticizing zone consisting of various two- and three-flight kneading blocks of various widths and also toothed blocks.

Located in the region of housings 9 to 10 is a mixing zone consisting of kneading elements, toothed blocks, and conveying elements.

Located in housing part 11 is vent 13 which is connected to an extraction apparatus (not shown).

Located in housing 12 is the pressurization zone and downstream thereof a die plate having 29 holes.

In example 4.1.1, a polycarbonate pellet material and a polycarbonate masterbatch obtained from example 4.1 according to the invention in the case of example 4.1.1, and the other molding compound constituents were metered into feed hopper 1 by means of commercially available gravimetric differential weigh feeders.

In example 6.1, polycarbonate pellet material, a polycarbonate masterbatch obtained according to this example 6.1 according to the invention, and the other molding compound constituents were metered into feed hopper 1 by means of commercially available gravimetric differential weigh feeders.

Pelletization was in examples 4.1.1 and 6.1 carried out in the form of strand pelletization after water-bath cooling.

The melt temperature was in examples 4.1.1 and 6.1 measured by inserting a thermocouple into the issuing melt of the central melt strand directly upstream of the die plate.

Located in the region of housings 15 to 18 is a conveying zone for a polycarbonate pellet material, a polycarbonate masterbatch, and the other solid molding compound constituents.

Located in the region of housing 19 is a plasticizing zone consisting of various two- and three-flight kneading blocks of various widths and also toothed blocks.

Located in the region of housings 21 to 23 is a mixing zone consisting of kneading elements, toothed blocks, and conveying elements.

Located in housing part 24 is vent 26 which is connected to an extraction apparatus (not shown).

Located in housing 25 is the pressurization zone and downstream thereof a die plate having 29 holes.

The co-kneader used for production of the polycarbonate masterbatch has a housing internal diameter of 58.4 mm, a screw element external diameter DE of 57.7 mm in the region of bearings, a screw element external diameter DE of 56.3 mm in the region outside the bearings, an L/D ratio of 15, a DE/DI ratio of 1.55 from the start of the co-kneader shaft up to the restrictor ring at the end of the melting zone, a DE/DI ratio of 1.71 from the restrictor ring up to the end of the co-kneader shaft, and a DE/stroke ratio of 5.5. The total length of the regions of the bearings is approx. 15% of the total length of the screw shaft of the continuous single-shaft kneader. The region from the start of the co-kneader shaft up to the restrictor ring amounts to 40% of the total length of the co-kneader shaft.

The basic construction of the continuous single-shaft kneader used is shown in FIG. 2. The continuous single-shaft kneader has a housing consisting of 3 parts, in which a rotating and simultaneously axially reciprocating screw shaft (not shown) is arranged.

The melt is discharged from the continuous single-shaft kneader by means of a single-screw extruder (not shown in FIG. 2) having a housing internal diameter of 110 mm and an L/D ratio of 6. The single-screw extruder is flanged directly onto the continuous single-shaft kneader, its sole purpose being for pressurization in the pelletization of the polycarbonate masterbatches. No significant mixing and/or comminution of all the masterbatch constituents takes place in the single-screw extruder. Located at the end of the single-screw extruder is a die plate having a diameter of 118.5 mm for the forming of the melt strands. The die plate contains 66 holes, each 3 mm in diameter, for discharging the melt. The melt strands issuing from the die plate were pelletized by hot-cut pelletization, i.e. the melt strands were chopped off by rotating knives in a flow of water.

The polycarbonate molding compounds produced in examples 1, 2.1.1, 3, 4.1.1, 5 and 6.1 were then processed via an injection-molding process on an FM160 injection-molding machine from Klockner into sheets having a glossy surface and dimensions of 150 mm×105 mm×3.2 mm (length×width×thickness).

The injection-molding machine has a cylinder diameter of 45 mm. The sheets were produced using an injection mold with gloss finish (ISO N1). The polycarbonate molding compounds were predried at 110° C. for 4 hours before injection molding. The processing by injection molding was carried out under the conditions characteristic for polycarbonates. During production of the sheets in examples 1, 2.1.1, 5, and 6.1, the melt temperatures were 280° C., the mold temperature was 80° C., the cycle time was 43 sec, and the injection speed was 40 mm/sec. During production of the sheets in examples 3 and 4.1.1, the melt temperatures were 300° C., the mold temperature was 90° C., the cycle time was 43 sec, and the injection speed was 40 mm/sec.

The surface of the sheets is recorded using a Zeiss Axioplan 2 light microscope, in bright field contrast of the incident light in a 16 cm² section with the aid of a scanning table. The light source used is the halogen 100 light source present in the microscope as reflected light source. The magnification was chosen so as to be able to detect structures on the sheet surfaces having a diameter greater than 10 μm. To achieve this, an Epiplan-Neofluar 2.5/0.075 HD lens, effective resolution 3.94 μm/pixel, is used. A surface region 4 cm×4 cm in size is examined by meandering scanning and photos of this surface are generated with an Axiocam HRC CCD camera. Surface defects are detected by automatic image evaluation of the photos with the microscope's own Zeiss KS 300 software. The number and diameter of the equivalent circle diameter (ECD) of the surface defects is determined. All surface defects having a size of at least 10 μm are used for the determination of surface defects. For the reporting of the size distribution of the defects, the recorded defect diameters are sorted into classes with a breadth of ten micrometers. For each test, measurements are carried out and evaluated on 3 sheets. The result of the measurement for the in each case 3 sheets is for the examined sheet surface the number of recorded surface defects per cm², their minimum and maximum diameter, the arithmetic mean value of the defect diameters for the 3 sheets, the median of the defect diameters for the 3 sheets, and the standard deviation of the defect diameters for the 3 sheets. The entire method is commercially available under the name SOP00014 “Plattenscan” from Currenta GmbH and Co. OHG, Germany. The values shown in Table 1 for the number of defects per cm², the average defect diameter, and the maximum defect diameter are in each case the arithmetic mean of the number of defects of at least 10 μm from measurements on 3 injection-molded sheets.

The specific surface quality of the injection-molded bodies produced from the molding compounds is in each case calculated from the arithmetic mean value for 3 injection-molded sheets from the number of defects per cm² multiplied by the mean defect diameter in gm divided by the reinforcing filler content of the molding compound in percent by weight, 1% by weight being calculated as 0.01 and 100% by weight as 1.00. The specific surface quality of the respective molding compounds is reported in Table 1. The higher the value for specific surface quality, the poorer the surface quality of the molding compound. All examples according to the invention have specific surface qualities of less than 550 all molding compound examples produced according to the prior art have specific surface qualities greater than 550 m⁴.

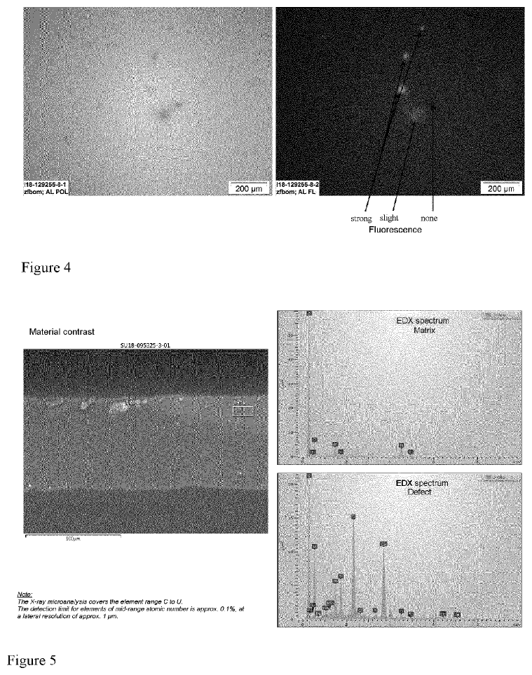

The surface defects optically detected in this way on moldings made from polymer mixtures having the abovementioned compositions are caused in particular by agglomerates or aggregates of titanium dioxide particles that are broken up insufficiently during melt mixing of the components in the extruder (see FIG. 3 (EDX spectrum for measurement point 04-01A) comprising relatively large proportions of titanium dioxide). The following additional particles capable of causing surface defects can be found in the mixture: degraded PC (see FIG. 4; recognizable by the fluorescence of the particles), metal-containing particles (see FIG. 5 (EDX spectrum for measurement point 3-01B); recognizable by the iron contained). The metal-containing particles can arise for example when polycarbonate adhering to the inner housing of the extruder flakes off and metal particles of the extruder housing are torn off therewith.

Without the inventors wishing to be bound to any particular scientific theory, it can reasonably be assumed that the particles of degraded polycarbonate and the metal-containing particles are caused by the increased input of energy from the twin-screw extruder into the polycarbonate molding compound that is necessary in order to achieve a dispersion approximating at least to dispersion of the polycarbonate molding compound using a continuous single-shaft kneader.

The molding compound fed into the extruder consists in example 1 of a mixture of:
93% by weight of pellets of a linear polycarbonate based on bisphenol A having a relative viscosity ηᵣₑₗ=1.255 (measured in CH₂Cl₂ as solvent at 25° C. and at a concentration of 0.5 g/100 ml) and
0.1% by weight of a maleic anhydride-grafted polyolefin copolymer (A-C 907P from Honeywell) and
6.99% by weight of a powder mixture comprising 3% by weight of a titanium dioxide powder (Kronos 2230 from Kronos Titan), 3.1882% by weight of a polycarbonate powder of a linear polycarbonate based on bisphenol A having a relative viscosity ηᵣₑₗ=1.255 (measured in CH₂Cl₂ as solvent at 25° C. and at a concentration of 0.5 g/100 ml) and also 0.0018% by weight of further colorants, 0.4% by weight of stabilizers, and 0.4% by weight of demolding agents.

The masterbatch composition fed into the co-kneader consists in examples 2.1, 4.1, and 6 of a mixture of:
58.7% by weight of pellets of a linear polycarbonate based on bisphenol A having a relative viscosity ηᵣₑₗ=1.293 (measured in CH₂Cl₂ as solvent at 25° C. and at a concentration of 0.5 g/100 ml) and
40% by weight of a titanium dioxide powder (Kronos 2230 from Kronos Titan) and
1.3% by weight of a maleic anhydride-grafted polyolefin copolymer (A-C 907P from Honeywell).

The molding compound fed into the extruder consists in example 2.1.1 of a mixture of:
88.4% by weight of pellets of a linear polycarbonate based on bisphenol A having a relative viscosity ηᵣₑₗ=1.255 (measured in CH₂Cl₂ as solvent at 25° C. and at a concentration of 0.5 g/100 ml) and
7.6% by weight of the polycarbonate masterbatch produced in example 2.1 and
4% by weight of a powder mixture comprising 3.29% by weight of a polycarbonate powder of a linear polycarbonate based on bisphenol A having a relative viscosity ηᵣₑₗ=1.255 (measured in CH₂Cl₂ as solvent at 25° C. and at a concentration of 0.5 g/100 ml) and also 0.31% by weight of stabilizers and 0.4% by weight of demolding agents.

The molding compound fed into the extruder consists in example 3 of a mixture of:
81% by weight of pellets of a linear polycarbonate based on bisphenol A having a relative viscosity ηᵣₑₗ=1.318 (measured in CH₂Cl₂ as solvent at 25° C. and at a concentration of 0.5 g/100 ml) and
14% by weight of a titanium dioxide powder (Kronos 2230 from Kronos Titan) and
5% by weight of a powder mixture comprising 3.51% by weight of a polycarbonate powder of a linear polycarbonate based on bisphenol A having a relative viscosity ηᵣₑₗ=1.318 (measured in CH₂Cl₂ as solvent at 25° C. and at a concentration of 0.5 g/100 ml) and also 1% by weight of a titanium dioxide powder (Kronos 2230 from Kronos Titan) and 0.49% by weight of a maleic anhydride-grafted polyolefin copolymer (A-C 907P from Honeywell).

The molding compound fed into the extruder consists in example 4.1.1 of a mixture of:
62.2% by weight of pellets of a linear polycarbonate based on bisphenol A having a relative viscosity ηᵣₑₗ=1.318 (measured in CH₂Cl₂ as solvent at 25° C. and at a concentration of 0.5 g/100 ml) and
37.8% by weight of the polycarbonate masterbatch produced in example 4.1.

The molding compound fed into the extruder consists in example 5 of a mixture of:
89% by weight of pellets of a linear polycarbonate based on bisphenol A having a relative viscosity ηᵣₑₗ=1.255 (measured in CH₂Cl₂ as solvent at 25° C. and at a concentration of 0.5 g/100 ml) and
6% by weight of a titanium dioxide powder (Kronos 2230 from Kronos Titan) and
5.02% by weight of a powder mixture comprising 3.265% by weight of a polycarbonate powder of a linear polycarbonate based on bisphenol A having a relative viscosity ηᵣₑₗ=1.255 (measured in CH₂Cl₂ as solvent at 25° C. and at a concentration of 0.5 g/100 ml) and also 0.75% by weight of a titanium dioxide powder (Kronos 2230 from Kronos Titan), 0.22% by weight of a maleic anhydride-grafted polyolefin copolymer (A-C 907P from Honeywell), 0.02% by weight of further colorants, 0.365% by weight of stabilizers, and 0.4% by weight of demolding agents.

The molding compound fed into the extruder consists in example 6.1 of a mixture of:
78.9% by weight of pellets of a linear polycarbonate based on bisphenol A having a relative viscosity ηᵣₑₗ=1.255 (measured in CH₂Cl₂ as solvent at 25° C. and at a concentration of 0.5 g/100 ml) and
17.1% by weight of the polycarbonate masterbatch produced in example 6 and
4.02% by weight of a powder mixture comprising 3.235% by weight of a polycarbonate powder of a linear polycarbonate based on bisphenol A having a relative viscosity ηᵣₑₗ=1.255 (measured in CH₂Cl₂ as solvent at 25° C. and at a concentration of 0.5 g/100 ml) and also 0.02% by weight of further colorants, 0.365% by weight of stabilizers, and 0.4% by weight of demolding agents.

### Comparative Example 1

In comparative example 1, the molding compound composition comprising 3% by weight of titanium dioxide is compounded at a throughput of 2100 kg/h, a screw-shaft speed of 600 l/min, and a resulting specific mechanical energy input of 0.174 kWh/kg. The temperature of the melt issuing from the die plate is 354° C.

The surfaces of three sheets injection-molded from the compounded molding compound have an average of 88 defects per cm², an average defect diameter of 20.1 μm, and a maximum defect diameter of 104.8 μm. The specific surface quality is 590 m⁻¹.

### Example 2.1

### According to the Invention—Polycarbonate Masterbatch

In example 2.1 according to the invention, the polycarbonate masterbatch composition comprising 40% by weight of titanium dioxide is compounded at a throughput of 120 kg/h, a speed of 200 l/min, and a resulting specific mechanical energy input of 0.067 kWh/kg. The temperature of the melt issuing from the die plate is 275° C.

### Example 2.1.1

### According to the Invention—Polycarbonate Molding Compound

In example 2.1.1 according to the invention, the molding compound composition comprising 3% by weight of titanium dioxide, introduced by means of the polycarbonate masterbatch produced according to example 2.1, is compounded at a throughput of 3000 kg/h, a screw-shaft speed of 500 l/min, and a resulting specific mechanical energy input of 0.142 kWh/kg. The temperature of the melt issuing from the extruder is 327° C.

The surfaces of three sheets injection-molded from the compounded molding compound have an average of 79 defects per cm², an average defect diameter of 20.1 μm, and a maximum defect diameter of 66.5 μm.

The specific surface quality is 529 m⁻¹.

Using the polycarbonate masterbatch according to the invention it was thus possible, by comparison with comparative example 1, to produce a molding compound having improved specific surface quality at a 43% higher throughput and 27° C. lower melt temperature.

### Comparative Example 3

In comparative example 3, the molding compound composition comprising 15% by weight of titanium dioxide is compounded at a throughput of 690 kg/h, a screw-shaft speed of 260 l/min, and a resulting specific mechanical energy input of 0.131 kWh/kg. The temperature of the melt issuing from the die plate is 326° C.

The surfaces of three sheets injection-molded from the compounded molding compound have an average of 2948 defects per cm², an average defect diameter of 40.8 μm, and a maximum defect diameter of 206.2 μm. The specific surface quality is 8019 m⁻¹.

### Example 4.1

### According to the Invention—Polycarbonate Masterbatch

In example 4.1 according to the invention, the polycarbonate masterbatch composition comprising 40% by weight of titanium dioxide is compounded at a throughput of 120 kg/h, a speed of 200 l/min, and a resulting specific mechanical energy input of 0.067 kWh/kg. The temperature of the melt issuing from the die plate is 275° C.

### Example 4.1.1

### According to the Invention—Polycarbonate Molding Compound

In example 4.1.1 according to the invention, the molding compound composition comprising 15% by weight of titanium dioxide, introduced by means of the polycarbonate masterbatch produced according to example 4.1, is compounded at a throughput of 690 kg/h, a screw-shaft speed of 260 l/min, and a resulting specific mechanical energy input of 0.139 kWh/kg. The temperature of the melt issuing from the extruder is 329° C.

The surfaces of three sheets injection-molded from the compounded molding compound have an average of 78 defects per cm², an average defect diameter of 16.2 μm, and a maximum defect diameter of 125 μm.

The specific surface quality is 84 m⁻¹.

Using the polycarbonate masterbatch according to the invention it was thus possible, by comparison with comparative example 3, to produce a molding compound having improved specific surface quality at an unchanged throughput and without any increase in energy input.

### Comparative Example 5

In comparative example 5, the molding compound composition comprising 6.75% by weight of titanium dioxide is compounded at a throughput of 720 kg/h, a screw-shaft speed of 270 l/min, and a resulting specific mechanical energy input of 0.132 kWh/kg. The temperature of the melt issuing from the die plate is 297° C.

The surfaces of three sheets injection-molded from the compounded molding compound have an average of 128 defects per cm², an average defect diameter of 32.3 μm, and a maximum defect diameter of 176.3 μm.

The specific surface quality is 613 m⁻¹.

### Example 6

### According to the Invention—Polycarbonate Masterbatch

In example 6 according to the invention, the polycarbonate masterbatch composition comprising 40% by weight of titanium dioxide is compounded at a throughput of 120 kg/h, a speed of 200 l/min, and a resulting specific mechanical energy input of 0.067 kWh/kg. The temperature of the melt issuing from the die plate is 275° C.

### Example 6.1

### According to the Invention—Polycarbonate Molding Compound

In example 6.1 according to the invention, the molding compound composition comprising 6.75% by weight of titanium dioxide, introduced by means of the polycarbonate masterbatch produced according to example 6, is compounded at a throughput of 720 kg/h, a screw-shaft speed of 270 l/min, and a resulting specific mechanical energy input of 0.138 kWh/kg. The temperature of the melt issuing from the extruder is 299° C.

The surfaces of three sheets injection-molded from the compounded molding compound have an average of 67 defects per cm², an average defect diameter of 20.5 μm, and a maximum defect diameter of 116.3 μm.

The specific surface quality is 203 m⁻¹.

Using the polycarbonate masterbatch according to the invention it was thus possible, by comparison with comparative example 5, to produce a molding compound having improved specific surface quality at an unchanged throughput and without any increase in energy input.

The process parameters and molding compound properties for experiments 1-6.1 (comparative and according to the invention) are summarized in Table 1.

TABLE 1

| | | | | | | | | | | Specific |
|---|---|---|---|---|---|---|---|---|---|---|
| | | | | | | | Surface defects | | | surface |
| | | | | | | | Arithmetic mean value of | | | quality |
| | | Content of | | | Specific | | measurement on 3 sheets | | | Arithmetic |
| | | reinforcing | | | mechanical | | | Average | Maximum | mean value of |
| | | filler | | | energy | Melt | | defect | defect | measurement |
| | | % by | Throughput | Speed | input | temperature | Defects/ | diameter | diameter | on 3 sheets |
| No. | | weight | kg/h | 1/min | kWh/kg | ° C. | cm² | [μm] | [μm] | m⁻¹ |
| 1 | Comparative | 3 | 2100 | 600 | 0.174 | 354 | 88 | 20.1 | 104.8 | 590 |
| 2.1.1 | According to | 3 | 3000 | 500 | 0.142 | 327 | 79 | 20.1 | 66.5 | 529 |
| | the invention | | | | | | | | | |
| 3 | Comparative | 15 | 690 | 260 | 0.131 | 326 | 2948 | 40.8 | 206.2 | 8019 |
| 4.1.1 | According to | 15 | 690 | 260 | 0.139 | 329 | 78 | 16.2 | 125 | 84 |
| | the invention | | | | | | | | | |
| 5 | Comparative | 6.75 | 720 | 270 | 0.132 | 297 | 128 | 32.3 | 176.3 | 613 |
| 6.1 | According to | 6.75 | 720 | 270 | 0.136 | 299 | 67 | 20.5 | 116.3 | 203 |
| | the invention | | | | | | | | | |

1. A process for producing a molding compound comprising the following molding compound constituents:
97% to 36% by weight of polycarbonate,
3% to 20% by weight of reinforcing filler, and
0% to 61% by weight of other molding compound constituents,
the sum of the molding compound constituents being 100% by weight, and wherein a masterbatch is first produced which comprises the following masterbatch constituents:
70% to 25% by weight of polycarbonate,
30% to 70% by weight of reinforcing filler, and
0% to 5% by weight of other masterbatch constituents,
the sum of the masterbatch constituents being 100% by weight, and wherein the process comprising compounding the masterbatch in a continuous single-shaft kneader in the following steps:
(1) adding polycarbonate and at least one reinforcing filler to a continuous single-shaft kneader, and
(2) compounding the polycarbonate and the at least one reinforcing filler using the continuous single-shaft kneader,
wherein the proportion of polyester in the masterbatch is not more than 0.9% by weight, and subsequently the following steps are carried out:
(3) adding the masterbatch and polycarbonate to a compounding unit, and
(4) compounding the masterbatch and polycarbonate using the compounding unit,
wherein the reinforcing filler comprises titanium dioxide, talc, dolomite, kaolinite, wollastonite, or any combination thereof,
and wherein
either the proportion of polyester in the molding compound is not more than 0.9% by weight, or
the proportion of polyester in the molding compound is not less than 22% by weight and not more than 58% by weight.

2. The process as claimed in claim 1, wherein the masterbatch comprises 35% to 65% by weight of reinforcing filler and 65% to 31% by weight of polycarbonate, the sum of the constituents being 100% by weight.

3. The process as claimed in claim 1, wherein the masterbatch comprises 0% to 5% by weight of other masterbatch constituents, the sum of the constituents being 100% by weight.

4. The process as claimed in claim 1, wherein the reinforcing filler is added in step (2) either before the polycarbonate has melted or after the polycarbonate has melted or both before and after the polycarbonate has melted.

5. The process as claimed in claim 1, to wherein the molding compound comprises 4.5% to 15% by weight of reinforcing filler and 95.5% to 41% by weight of polycarbonate, the sum of the constituents being 100% by weight.

6. The process as claimed in claim 5, wherein the molding compound comprises 0% to 54.5% by weight of other molding compound constituents, the sum of the constituents being 100% by weight.

7. The process as claimed in claim 1, wherein the compounding unit is selected from the group consisting of continuous single-shaft kneaders, multishaft extruders, planetary roller extruders, ram kneaders, and internal mixers.

8. A molding compound produced by the process as claimed in claim 1.

9. The molding compound as claimed in claim 8, wherein the molding compound is suitable for producing an injection-molded article having a specific surface quality less than or equal to 550 m⁻¹.

10. A method comprising producing a molded article, a reflector for a light, or a structural component with the molding compound as claimed in claim 8.

11. An injection-molded article produced from the molding compound as claimed in claim 8, wherein the injection-molded article has a specific surface quality less than or equal to 550 m⁻¹.

12. The process as claimed in claim 1, wherein the reinforcing filler comprises titanium dioxide, talc, or a combination thereof.

13. The process as claimed in claim 2, wherein the masterbatch comprises 40% to 60% by weight of reinforcing filler.

14. The process as claimed in claim 2, wherein the masterbatch comprises 59.5% to 37% by weight of polycarbonate.

15. The process as claimed in claim 3, wherein the masterbatch comprises 0% to 3% by weight of other masterbatch constituents.

16. The process as claimed in claim 6, wherein the molding compound comprises 0% to 25% by weight of other molding compound constituents.

17. The process as claimed in claim 7, wherein the multishaft extruders are twin-screw extruders or ring extruders.

18. The process as claimed in claim 7, wherein the compounding unit is a co-rotating twin-screw extruder.

19. The molding compound as claimed in claim 9, wherein the molding compound is suitable for producing an injection-molded article having a specific surface quality less than or equal to 250 m⁻¹.

20. The injection-molded article as claimed in claim 11, wherein the injection-molded article has a specific surface quality less than or equal to 250 m⁻¹.
